(19) United States
(12) Patent Application Publication
(10) Pub. No.: US 2003/0160831 A1
(43) Pub. Date: Aug. 28, 2003

(54) System for indicating the stability of application programs through indicators associated with icons representing the programs in the graphical user interface of a computer controlled display

(75) Inventors: Mark Edward Ball, Austin, TX (US); Jessica Murillo, Hutto, TX (US); Johnny Meng-Han Shieh, Austin, TX (US)

Correspondence Address: Leslie A. Van Leeuwen, International Business Machines Corporation, Intellectual Property Law Dept. Internal Zip 4054, 11400 Burnet Road, Austin, TX, 78758, US

(73) Assignee: International Business Machines Corporation, Armonk, NY (US)

(21) Appl. No.: 10/082,414

(22) Filed: Feb. 26, 2002

(51) Int. Cl. G09G 5/00

(52) U.S. Cl. 345/835; 345/764

(57) ABSTRACT

Dynamically tracking the stability of application programs used in a computer system and for indicating the stability state of such programs to the user through a graphical user interface. Computer controlled user interactive display systems with graphical user interfaces store a plurality of application programs and present a GUI with a plurality of icons, each of which is representative of one of said application programs. A user is enabled to interactively select any of said displayed objects to thereby run the application program represented by the object. The rates of unrequested interruptions in the runs of each of said application programs, and there is an implementation associated with each of said objects for displaying a visual indicator of the rate of unrequested interruption in the run of the application program represented by the object. The interruptions tracked are primarily unrequested closings in the run of the application programs, i.e. crashes.

### TECHNICAL FIELD

The present invention relates to user interactive computer supported display technology and particularly to such user interactive systems and methods that are user friendly and provide interactive users with a graphical user interface (GUI) in which the application programs in the system are represented by displayed icons.

### BACKGROUND OF RELATED ART

The last decade has been marked by a technological revolution driven by the convergence of the data processing and consumer electronics industries together with the explosion of the World Wide Web (Web) or Internet. As a result, extraordinary world wide communication channels and resources have become available to businesses, and this has forever changed how many businesses and industries develop products, as well as the time cycles of such product development.

Nowhere are these dramatic changes in product development more apparent than in the development, testing and eventual production of computer software products. Over its first forty years, prior to the 1980's, the software development environment was one in which an individual or a small dedicated group willing to put in long hard hours could create “elegant” software or “killer applications” directed to and effective in one or more of the limited computer system environments existing at the time.

Unlike hardware or industrial product development, the development of software did not require substantial investment in capital equipment and resources. Consequently, in the software product field, the business and consumer marketplace to which the software is directed has traditionally expected short development cycles from the time that a computer need and demand became apparent to the time that a commercial software product fulfilling the need became available.

Unfortunately, with the explosion of computer usage and the resulting wide diversity of computer systems that must be supported by, or at least not be incompatible with, each newly developed computer software product, the development cycles have become very complex. Even when the software product development is an upgrade of an existing product, every addition, subtraction or modification of the program could have an insignificant or a profound effect on another operating system or application program that must be supported.

During the evolution of the software industries over the past two decades, it has been evident that developing software will be combined in new and often unforeseen ways, and, thus, there is an increased likelihood that the individual developments will drive system programs that must be supported into inoperable states for certain purposes or under certain conditions. This changed development environment has caused many traditional and responsible software development houses to take the time and make the effort to resolve all potential incompatibilities with all existing and standard software before the new developed software products were commercially released. Unfortunately, the computer industry landscape is littered with the “corpses” of such responsible longer development cycle software houses that lost out to newer software product entrepreneurs who rushed to the market with unresolved incompatibilities.

As a result, even reliable software houses have to sacrifice uncompromising reliability for some expediency, and put software application programs into the market with some imperfections. At first, this led to a distrust of new software products by consumers and businesses, i.e. a new software product will lead to down time until incompatibilities are resolved. However, continued advances in software technology have brought such profound advantages to consumers, business and industry that the marketplace in application programs has come around to accepting that new programs will produce some incompatibilities with installed software that may lead to crashes, i.e. premature interruptions and closures of program runs. Thus, the emphasis now is to minimize the ancillary and side effects of such program crashes. The present invention provides an implementation to help the user to minimize the ancillary effects.

### SUMMARY OF THE INVENTION

The present invention provides a method and system for dynamically tracking the stability of application programs used in a computer system and for indicating the stability state of such programs to the user through a graphical user interface. The invention relates to computer controlled user interactive display systems with a graphical user interface and means for storing a plurality of application programs, as well as a GUI with a plurality of displayed objects such as icons, each of which is representative of one of said application programs. It has standard means enabling a user to interactively select any of said displayed objects to thereby run the application program represented by the object. The rates of unrequested interruptions in the runs of each of said application programs are calculated; and associated with each of said objects or icons, there is a display of a visual indicator of the rate of unrequested interruption in the run of the application program represented by the object.

The interruptions tracked are primarily unrequested closings in the run of the application programs, i.e. crashes. Such crashes are easy to track. Each time one of the application programs is opened, a one is added to a total count for the program and some signal or flag is set that the program is running. Then, in the case of a conventional closure of the program, e.g. by clicking on the “X” box or through selection of “FILE” . . . “CLOSE”, on the GUI, the signal or flag is removed. However, if the application program crashes, with no conventional closure, the flag remains and results in a count of “one” being added to a crash total being maintained for each program. Then, using the ratio of the crash count to the total opening of program count, an unrequested closing or crash rate level may be determined for each application program.

The indicator associated with each icon representing an application program symbolizes this rate level for the program. Effective display may be achieved by a colored band around the icon, with the color being selected from a scale of colors representing the various rate levels. The color may be dynamically changed when, over a period of time, the application becomes more or less stable and the rate level of crashes changes.

The advantage of the invention is that it gives the user options in using his system. For example, if he must have his computer system available at 11 AM, he may not wish to take the risk of running a program at 10:50 AM if its icon indicates it has a questionable crash rate level, since it may result in the system being down at the critical 11 AM time. Instead, he may chose to run the risky program at 11:30 AM when time is less critical.

In another situation, the user may be maintaining a few versions of the same application program where older versions may have less computing power but more stability. If in a hurry, the user viewing the stability levels through the icons may choose to use the lower powered, but more stable, program, particularly for simpler functions.

It has been noted, that with time most newer programs tend to stabilize, either because their flaws and incompatibilities are corrected or as a result of the user removing other unneeded software from the system that may cause conflicts with the programs in question. The present invention dynamically tracks and displays such development through the program icon indicators so that the user may continually reconcile his usage of the program to its stability during this period of transition. Thus, the invention serves to minimize user inconvenience in the enhancement of his computer operations through the adding of new application programs.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of an interactive data processor controlled display system including a central processing unit that is capable of implementing the present invention of tracking the crash rate of a plurality of application programs and displaying variations in such crash rates by varying the color of a border around the GUI icons representing the programs;

FIG. 2 is a diagrammatic starting view of a display screen with a group of icons representative of application programs stored in the system;

FIG. 3 is the same diagrammatic view of the display screen of FIG. 2 with the icons surrounded with bands of color indicators representative of the crash rates, i.e stability of the programs;

FIG. 4 is a general flowchart of a program set up to implement the present invention for tracking the crash rate of a plurality of application programs and displaying variations in such crash rates by varying the color of a border around the GUI icons representing the programs; and

FIG. 5 is a flowchart of an illustrative run of a program set up in accordance with the flowchart of FIG. 4.

### DETAILED DESCRIPTION OF THE PREFERRED EMBODIMENT

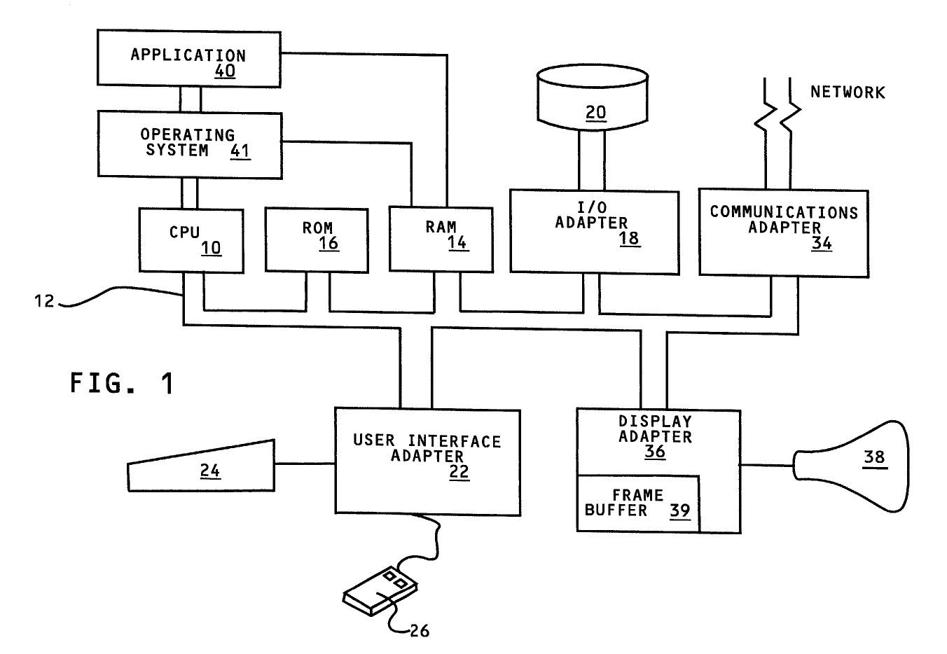

Referring to FIG. 1, a typical generalized data processing system display terminal is shown that may function as the computer controlled display terminal used for tracking the crash rate of a plurality of application programs and displaying variations in such crash rates by varying the color of a border around the GUI icons representing the programs. A central processing unit (CPU) 10, such as any PC microprocessor in a PC available from International Business Machines Corporation (IBM) or Dell Corp., is provided and interconnected to various other components by system bus 12. An operating system 41 runs on CPU 10, provides control and is used to coordinate the function of the various components of FIG. 1. Operating system 41 may be one of the commercially available operating systems such as Microsoft's Windows98™ or WindowsNT™, as well as the UNIX or AIX operating systems. An application program that tracks the crash rate of a plurality of application programs and displays variations in such crash rates by varying the color of a border around the GUI icons representing the programs, to be subsequently described in detail, runs in conjunction with operating system 41 and provides output calls to the operating system 41, which, in turn, implements the various functions to be performed by the application 40. A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 may be a Small Computer System Interface (SCSI) adapter that communicates with the disk storage device 20, i.e. a hard drive. Communications adapter 34 interconnects bus 12 with an outside network enabling the data processing system to communicate with other such systems over a Local Area Network (LAN) or a Wide Area Network (WAN), which includes, of course, the Internet or Web. I/O devices are also connected to system bus 12 via user interface adapter 22 and display adapter 36. Keyboard 24 and mouse 26 are all interconnected to bus 12 through user interface adapter 22. Mouse 26 operates in a conventional manner insofar as user movement is concerned. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned mouse or related devices, a user is capable of inputting information to the system through the keyboard 24 or mouse 26 and receiving output information from the system via display 38.

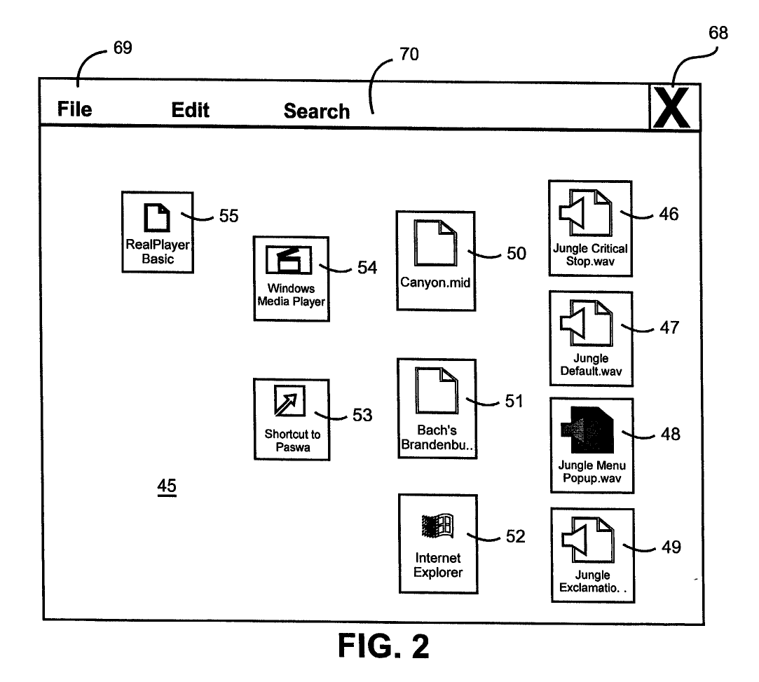

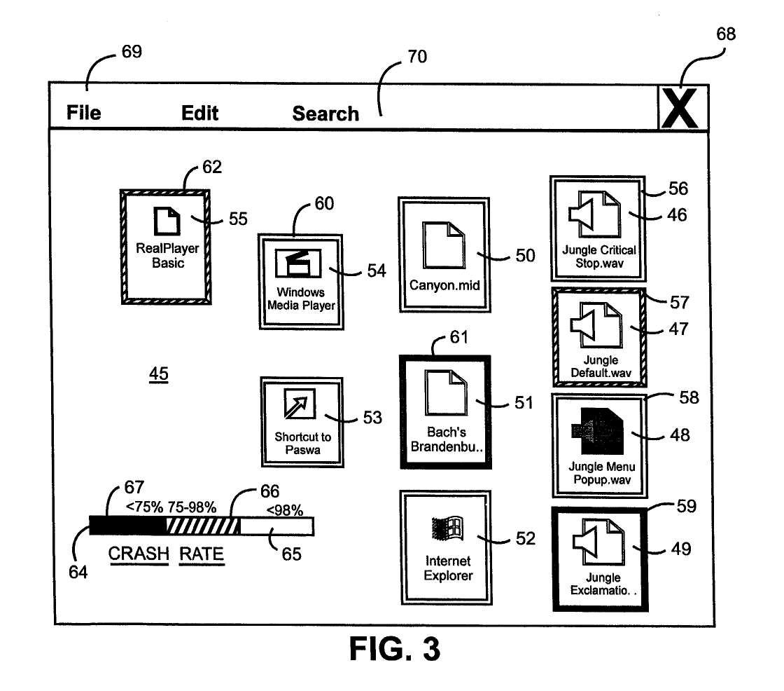

With reference to FIG. 2, the display screen 45 GUI shown as a typical group of icons, 46 through 55, each representative of a stored application program. The user is enabled to select any of the application programs represented by the icons by clicking on the icon using a conventional mouse pointer to thereby select and run the application program represented by the icon. Once a program is selected to be run, the user may normally terminate the run of the program, e.g. by either clicking on “X” 68 in a bar menu 70 or clicking on “FILE” item 69 to drop down a conventional function menu (not shown), and to select “CLOSE” from that menu. As will be described hereinafter, the system counts each opening of each application program, and when the user conventionally closes each program, as described, the system does not make a further tally. However, if the program closes without any such user request or action, this is regarded as a crash of the program and such a closure is tallied as one count being added to a count of crashes being maintained for each application program. This information is then used to calculate a failure rate for each application program and each failure rate for each icon is categorized in a failure rate level. Then, the failure rate level for the application program represented by an icon is indicated by the assignment of a color to a peripheral band surrounding the icon. These colored bands, 56 through 62, shown in FIG. 3, surrounding their respective icons indicate such failure rate levels. A Crash Rate scale 64 may be displayed on GUI 64 to orient the user in the rate levels represented by the colors. Thus, in the scale shown, the green color 65 indicates a failure rate level of greater than 98%, the yellow color 66 indicates a failure rate level of 75% to 98%, while the red color 67 indicates a failure rate level less than 75%. The bands 56 through 62 reflect such failure rate levels. It should be noted that the tracking is continuous over a given period of time and, as the tracked failure rate levels for particular application programs change during the tracked period, the colors in bands 56 through 62 may be dynamically changed. In this connection, note that there are four versions of a program, “Jungle” as represented by icons 46 through 49. Thus, the users, by viewing the colors of the respective bands 56 through 59 of these icons, may be informed of the application program versions' failure rate levels and be able to select and use the version most appropriate to their needs, but tempered in their selection by their insight into the failure rates of the programs.

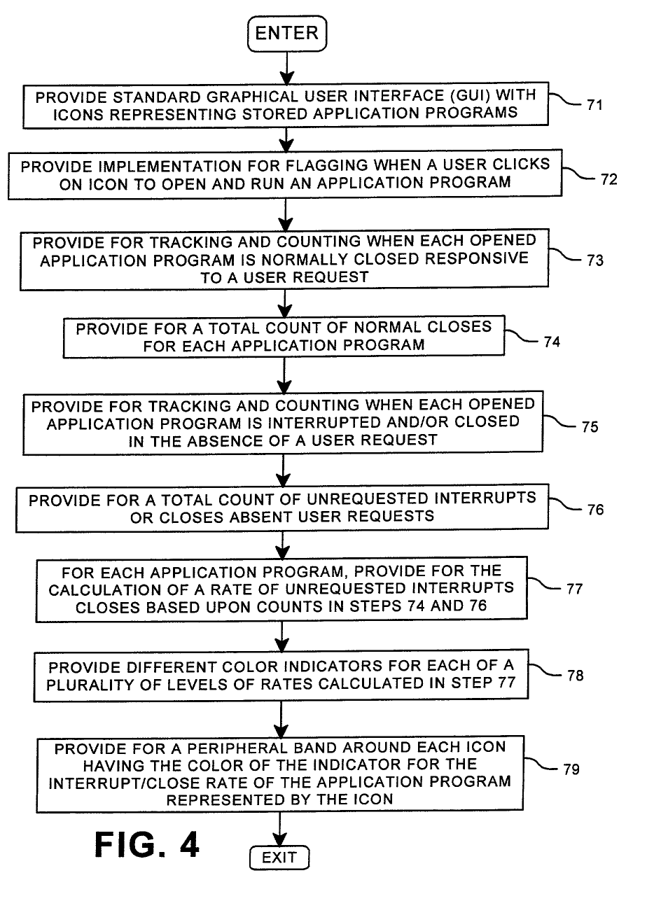

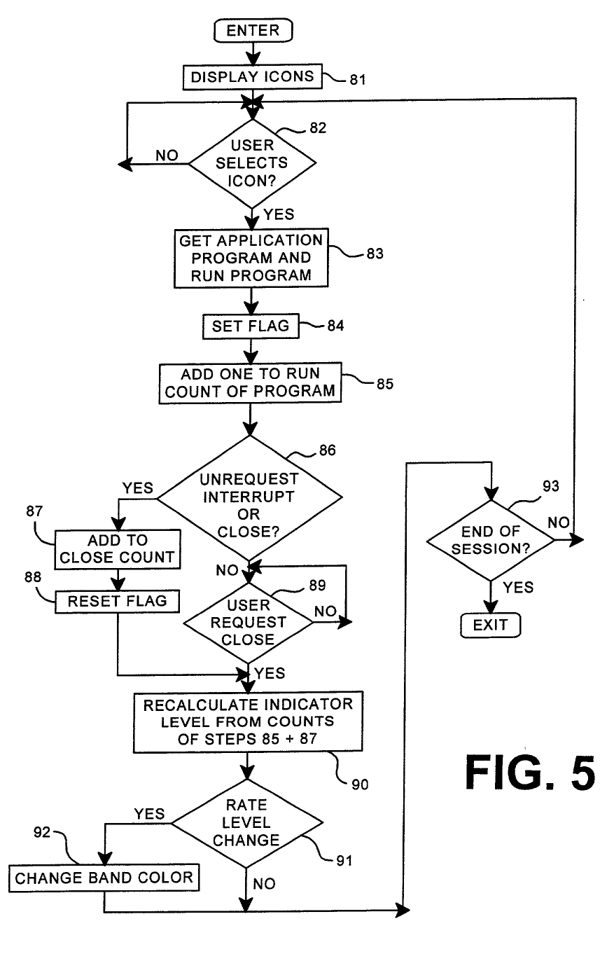

Now, with reference to FIGS. 4 and 5, we will describe a process implemented by the present invention in conjunction with the flowcharts of these figures. FIG. 4 is a flowchart showing the development of a process according to the present invention for tracking the crash rate of a plurality of application programs and displaying variations in such crash rates by varying the color of a border around the GUI icons representing the programs. A standard GUI is provided with icons representing stored application programs, step 71. An implementation is provided for setting a flag whenever a user clicks an icon to thereby open and run an application program, step 72. There is provision for tracking and then counting when each opened application is normally closed, step 73, pursuant to a user request to thereby count all normally closed application programs, step 74. This is an alternate process to the previously described process where all opens are counted along a count of only the crashed opened programs. Then, in both approaches, programs closed without a user request, i.e. crashed programs are counted, step 75, and the crashes are totaled, step 76. Then, for each application program there is provided an implementation for the calculation of the rate of unrequested closes based upon the previous counts, step 77. Different color indicators for icon bands are provided for each of a plurality of the calculated levels of rates, step 78.

The running of the process will now be described with respect to FIG. 5. First, step 81, the icons are conventionally displayed on the GUI display screen and a determination is made as to whether the user selected an icon, step 82. If No, the process is branched back to step 82 where a selection of an icon is awaited. If Yes, an icon has been selected, then, step 83, the application program is retrieved and run. When the run of the program has begun, a flag is set, step 84. A count of the number of times that a run of each particular program is begun is being kept and one is added to the total count, step 85. Also tracked is whether the opened program run is subject to an unrequested close, step 86. If Yes, then one is added to another count, that of closes of the program that have not been requested, i.e. crashes for each of the application programs, step 87. On the other hand, if the determination in step 86 is No, there has been no crash, then a further determination is made as to whether the user has made a conventional request to close the program, step 89. If No, the running of the program is continued until there is such a user request to close, step 89. If Yes, there is such a request, then the level of failure or crash rate is recalculated using the previously described counts, step 90. A determination is then made, step 91, as to whether the recalculation has resulted in a change in the crash rate level. If Yes, the color of one or more of the icon color bands is changed to reflect the change, step 92. After either steps 91 or 92, a determination may conveniently be made as to whether a decision to end the session is made, step 93. If Yes, the session is ended. If No, the process is branched back to step 82 where the selection of another icon by a user is awaited.

One of the implementations of the present invention is as an application program 40 made up of programming steps or instructions resident in RAM 14, FIG. 1, during computer operations. Until required by the computer system, the program instructions may be stored in another readable medium, e.g. in disk drive 20 or in a removable memory such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A computer controlled user interactive display system with a graphical user interface comprising:
means for storing a plurality of application programs;
a plurality of displayed objects, each representative of one of said application programs;
means enabling a user to interactively select any of said displayed objects to thereby run the application program represented by the object;
means for tracking the rates of unrequested interruptions in the runs of each of said application programs; and
means associated with each of said objects for displaying a visual indicator of the rate of unrequested interruption in the run of the application program represented by the object.

2. The computer controlled user interactive display system of claim 1 wherein said unrequested interruptions are closings in the runs of said application programs.

3. The computer controlled user interactive display system of claim 2 wherein said displayed objects are icons.

4. The computer controlled user interactive display system of claim 3 wherein said visual indicator comprises a set of colors, each color in the set indicating a rate level of said unrequested closing.

5. The computer controlled user interactive display system of claim 4 wherein said visual indicator of said color is in the form of a band around the icon.

6. The computer controlled user interactive display system of claim 4 wherein a plurality of the stored application programs represented by said icons are different versions of the same application program.

7. In a computer controlled user interactive display system with a graphical user interface, a method for indicating the stability of application programs used in the system comprising:
storing a plurality of application programs;
displaying a plurality of objects, each representative of one of said application programs;
enabling a user to interactively select any of said displayed objects to thereby run the application program represented by the object;
tracking the rates of unrequested interruptions in the running of each of said application programs; and
displaying, in association with each of said objects, a visual indicator of the rate of unrequested interruption in the running of the application program represented by the object.

8. The method of claim 7 wherein said unrequested interruptions are closings in the runs of said application programs.

9. The method of claim 8 wherein said displayed objects are icons.

10. The method of claim 9 wherein said visual indicator comprises a set of colors, each color in the set indicating a rate level of said unrequested closing.

11. The method of claim 10 wherein said visual indicator of said color is in the form of a band around the icon.

12. The method of claim 10 wherein a plurality of the stored application programs represented by said icons are different versions of the same application program.

13. A computer program having program code included on a computer readable medium for indicating the stability of an application program used in a computer controlled user interactive display system with a graphical user interface comprising:
means for storing a plurality of application programs;
a plurality of displayed objects, each representative of one of said application programs;
means enabling a user to interactively select any of said displayed objects to thereby run the application program represented by the object;
means for tracking the rates of unrequested interruptions in the runs of each of said application programs; and
means associated with each of said objects for displaying a visual indicator of the rate of unrequested interruption in the run of the application program represented by the object.

14. The computer program of claim 13 wherein said unrequested interruptions are closings in the runs of said application programs.

15. The computer program of claim 14 wherein said displayed objects are icons.

16. The computer program of claim 15 wherein said visual indicator comprises a set of colors, each color in the set indicating a rate level of said unrequested closing.

17. The computer program of claim 16 wherein said visual indicator of said color is in the form of a band around the icon.

18. The computer program of claim 16 wherein a plurality of the stored application programs represented by said icons are different versions of the same application program.
